(19) United States
(12) Patent Application Publication
(10) Pub. No.: US 2008/0118332 A1
(43) Pub. Date: May 22, 2008

(54) DRYWALL SCREW

(76) Inventor: David Lamb, Plainfield, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/560,464

(22) Filed: Nov. 16, 2006

(51) Int. Cl. F16B 33/02; E04B 1/00

(52) U.S. Cl. 411/411; 52/741.1

(57) ABSTRACT

A screw type fastener for use in fastening drywall to a structural member while generating a gap between structural member and drywall to produce sound insulation, the fastener including a shank having a head end and a point end, a first threaded section and a second threaded section, said first threaded section being closer to said point end than said second threaded section, said first threaded section having threads that have a first pitch and first thread diameter, said second threaded section having threads that have a second pitch and a second thread diameter larger than said first thread diameter, wherein when the screw type fastener is screwed through drywall into a structural member, a gap is generated between said structural member and drywall.

### TECHNICAL FIELD

This claimed technology relates generally to screw type fasteners and, more particularly, to a drywall screw that generates a gap between structural member and drywall to produce sound insulation.

### BACKGROUND

Gypsum board (commonly referred to as “drywall”) is a common artificial building material used globally for the construction of interior walls and ceilings. Drywall is made primarily from gypsum plaster, the semi-hydrous form of calcium sulphate (CaSO_{4.}½H₂O). The plaster is mixed with fiber (typically paper and/or fiberglass), foaming agent, various additives that increase mildew and fire resistance, and water, and is then formed by sandwiching a core of wet gypsum between two sheets of heavy paper or fiberglass mats. When the core sets and is dried, the sandwich becomes rigid and strong enough for use as a building material.

Drywall is typically available in 4 ft. (approx. 1200 mm) wide sheets of various lengths. Newly formed sheets are cut from a belt, the result of a continuous manufacturing process. In some commercial applications, sheets up to 16 ft. are used. Larger sheets make for faster installation, since they reduce the number of joints that must be finished. Often, a sizable quantity of any custom length may be ordered, from factories, to exactly fit ceiling-to-floor on a large project. The most commonly used drywall is about ½ in. thick, but can range from ¼ in. (6.35 mm) to 1 in. (25 mm).

During construction, drywall is cut to size, using a large T-square, by scoring the paper on the front side (usually white) with a utility knife, breaking the sheet along the cut, scoring the paper backing, and finally breaking the sheet in the opposite direction. Small features such as holes for outlets and light switches are usually cut using a keyhole saw or a small high-speed bit in a rotary tool. Drywall is then fixed to the wall structure with nails, or more commonly in recent years, specially designed screws. Drywall screws typically have an acute point, widely spaced threads, and a curved top, allowing them to self-pilot and install rapidly without punching through the paper cover.

Repairs are commonly needed when screws or nails work themselves loose or pop out of a drywall surface. A “pop” is an imperfection that occurs in drywall when the point of attachment of drywall to the wood framing of the house fails. Average pops are usually about the size of a quarter and are either convex or concave, depending upon the cause. Either the drywall moved and the screw stayed still, or the screw moved and the drywall stayed still. Both result in a pop. Sometimes the screw or nail head becomes exposed. Screwing or pounding them back into place usually does not prevent the problem from recurring. As such, substantial drywall repair is required to fix even a minor pop. Current screws available in the marketplace do not fully prevent the likelihood that a pop will occur.

Another common problem with drywall is that it easily transmits noise between rooms. Sound waves hit structural components, like walls, and the sound energy vibrates the wall. The wall, in turn, transmits the energy and creates a new wave on the other side. When a common wall separates two rooms, the sound generated in both rooms carries between them. Drywall, which is fairly flexible, is good at transmitting sound.

Air space serves to dampen sound waves. Sound attenuates, or loses energy, as it travels through the still air, just as the ripple from a rock thrown in a pond will grow smaller and smaller as it radiates outwards through the water. As such, it would be beneficial to leave a gap or space filled with dead air between the drywall and stud (or other framing), thus contributing to sound insulation. The present drywall screw addresses these needs.

### SUMMARY

The following is not in any way to limit, define or otherwise establish the scope of legal protection. In general terms, the present claimed technology relates to a drywall screw. One object is to provide an improved drywall screw that generates a gap between structural member and drywall to produce sound insulation. Further objects, embodiments, forms, benefits, aspects, features and advantages of the claimed technology may be obtained from the description, drawings and claims provided herein.

### BRIEF DESCRIPTION OF THE DRAWINGS

FIG. 1 is a perspective side view of a preferred embodiment drywall screw of the present novel technology.

FIG. 2 is a top view of the preferred embodiment drywall screw, as shown in FIG. 1.

FIG. 3 is a series of fragmentary sectional views of the embodiment of FIG. 1 penetrating a workpiece of drywall and the supporting structure.

FIG. 4A is a side sectional view of the embodiment of FIG. 1 poised to penetrate a section of drywall.

FIG. 4B is a side sectional view of the embodiment of FIG. 1 extending through a section of drywall and partially into an underlying support member.

FIG. 4C is a side sectional view of the embodiment of FIG. 1 extending through a section of drywall and into the underlying support member, wherein a gap is produced between the drywall and the support member.

FIG. 4D is a side sectional view of the embodiment of FIG. 1 extending through a section of drywall and into the underlying support member, wherein a gap is produced between the drywall and the support member, wherein the drywall screw has self-set into the drywall.

### DESCRIPTION OF THE PREFERRED EMBODIMENTS

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

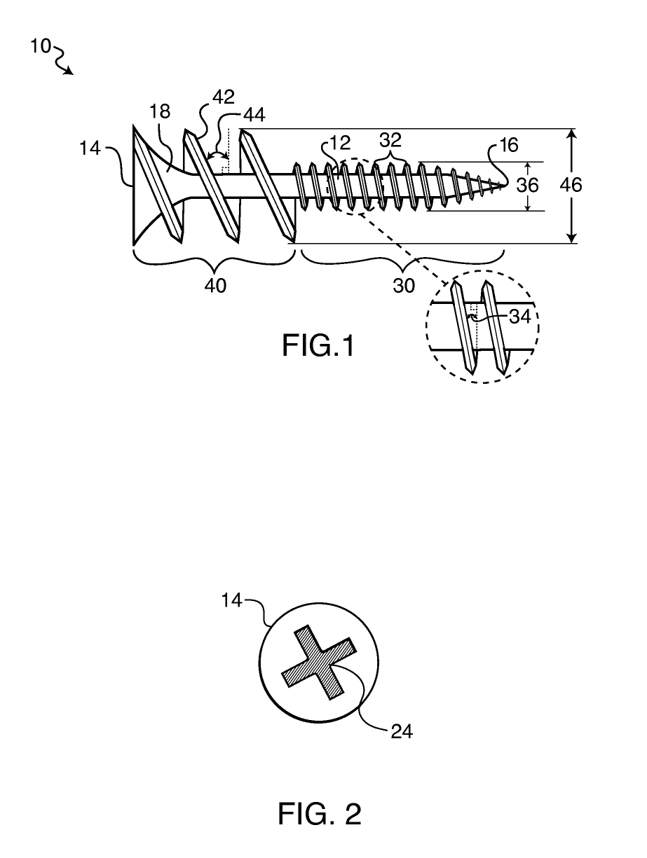

FIG. 1 illustrates a first embodiment of a screw type fastener 10 comprising a shank 12 having a head end 14 and a point end 16. The head end 14 is also seen to include an arcuately conical portion 18 that converges toward the shank 12. This head end 14, in combination with the conical portion 18, is commonly referred to in the art as a “bugle” head, and the conical portion 18 serves as the sole compacting surface on traditional drywall screws.

The fastener 10 includes a first threaded section 30 and a second threaded section 40, said first threaded section 30 being closer to said point end 16 than said second threaded section 40. The threads 32 of the first threaded section 30 are characterized by a first pitch 34, and the threads 42 of the second threaded section 40 have a second pitch 44. The first pitch 34 is greater than the second pitch 44. Further, the threads 32 of the first threaded section 30 have a first thread diameter 36, and the threads 42 of the second threaded section 40 have a second thread diameter 46 larger than the first thread diameter 36.

The shank 12 is typically of uniform diameter and is relatively thin compared to the dimensions of the threads 42 of the second threaded section 40, such that drywall dust is compressed between the threads 42 rather than building up and causing drywall pops.

As shown in FIG. 2, the head end 14 may include a recess 24 for receiving a driving element, and is specifically shown to be designed to receive a Phillips-head screwdriver.

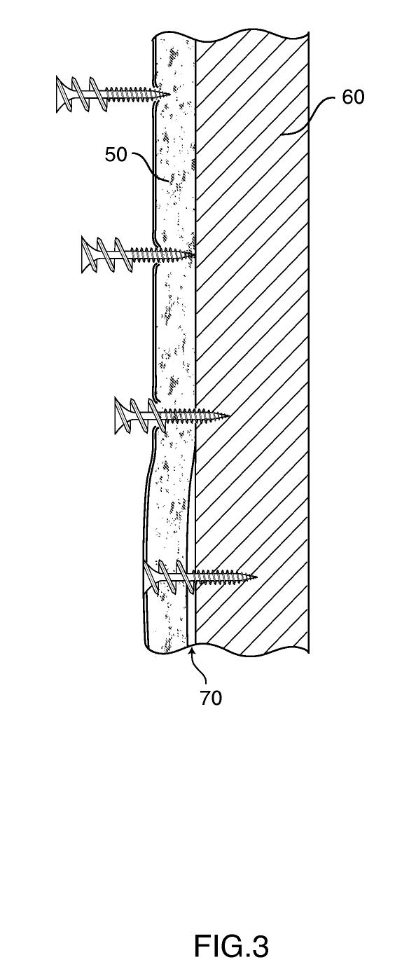

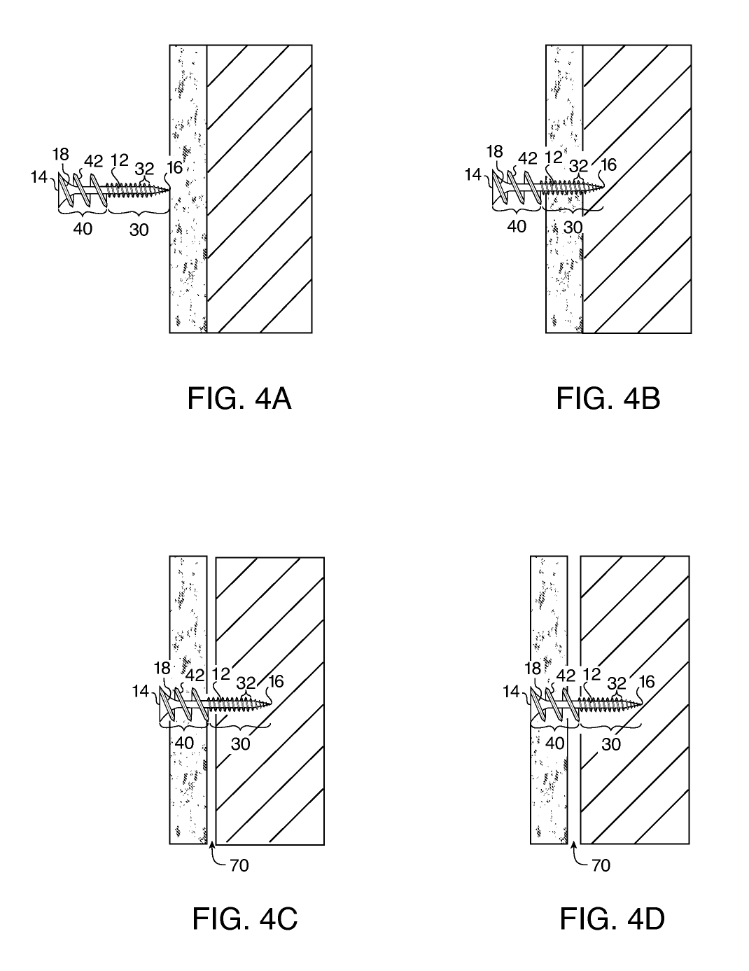

Turning now to FIGS. 3-4, the fastener 10 and its use will be further explained in more detail. Prior to fastening, a sheet of drywall 50 is positioned against a structural member 60, such as a wooden stud. The point end 16 of the fastener 10 is placed in the desired location for fastening, and pressure is exerted on the head end 14. The shank 12 is then rapidly turned to screw the fastener 10 through the drywall into the structural member 60. One advantage of the present technology is that, due to the spacing, frequency and pitch of the threads 32 of the first portion 30 being different (typically more narrowly spaced and/or more steeply pitched) than the threads 42 of the second portion 40, the first portion 30 penetrates the structural member 60 faster than the second portion 40 penetrates the drywall 50, resulting in an engineered gap 70 (typically 1/32 to 1/16 of an inch) between the two. This gap 70 contributes substantially to sound insulation.

Further, the length of the second portion 40 may be matched to the thickness of the drywall 50, such that the fastener 10 automatically sets and stops when the second portion 40 begins to engage the structural member 60, since substantially greater torque is required to drive the wider and larger threads of the second portion 40 through a wood stud (or other such structural materials more dense than drywall).

Another advantage of the present technology is that “popping” of the fastener 10 is minimized, since the fastener 10 tends to grip and pull the drywall 50 outwardly with it instead of popping through as the structure 60 settles.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A screw type fastener, comprising:
a shank having a head end and a point end;
said shank having a first threaded section and a second threaded section, said first threaded section being disposed closer to said point end than said second threaded section;
said first threaded section having threads defining a first pitch, said second threaded section having threads defining a second pitch, wherein said first pitch is greater than said second pitch;
said first threaded section having a first thread diameter, said second threaded section having a second thread diameter larger than said first thread diameter;
wherein when the screw type fastener is screwed through drywall into a structural member, a gap is generated between said structural member and drywall.

2. The screw type fastener as in claim 1, wherein said head end has a recess to accommodate a driving tool.

3. The screw type fastener as in claim 1, wherein said first thread diameter is about 3-5 millimeters.

4. The screw type fastener as in claim 1, wherein said second thread diameter is about 12-16 millimeters.

5. The screw type fastener as in claim 1, wherein the gap generated is about 4-6 millimeters.

6. The screw type fastener as in claim 1, wherein the first threaded section is substantially adjacent the second threaded section.

7. A method of hanging drywall, the method comprising the steps of:
a) providing at least one screw type fastener, the screw type fastener comprising:
a shank having a head end and a point end;
said shank having a first threaded section and a second threaded section, said first threaded section being closer to said point end than said second threaded section;
said first threaded section having threads that have a first pitch, said second threaded section having threads that have a second pitch, wherein said first pitch is greater than said second pitch;
said first threaded section having a first thread diameter, said second threaded section having a second thread diameter larger than said first thread diameter; and
b) positioning a sheet of drywall against a structural member;
c) rotating said screw type fastener, wherein the screw type fastener screws through said drywall into said structural member, thereby generating a gap between structural member and drywall to produce sound insulation.

8. The method of hanging drywall as in claim 7, wherein said head end has a recess to accommodate a driving tool.

9. The method of hanging drywall as in claim 7, wherein said first thread diameter is about 3-5 millimeters.

10. The method of hanging drywall as in claim 7, wherein said second thread diameter is about 12-16 millimeters.

11. The method of hanging drywall as in claim 7, wherein the gap generated is between about 4 and about 6 millimeters.

12. The method of hanging drywall as in claim 7, wherein the first threaded section is substantially adjacent the second threaded section.

13. A method for securing a section of drywall to a supporting structure, the method comprising the steps of:
introducing into the drywall a fastener having a shank with a head end and a point end, the shank having a first threaded section and a second threaded section, said first threaded section being closer to said point end than said second threaded section; the first threaded section having threads that have a first pitch, the second threaded section having threads that have a second pitch, wherein said first pitch is greater than said second pitch; the first threaded section having a first thread diameter, said second threaded section having a second thread diameter larger than said first thread diameter;
rotating the fastener so that the point end proceeds through the drywall towards the supporting structure;
causing the second threaded section to engage the drywall, thereby generating a gap between structural member and drywall to produce sound insulation.

14. The method of securing a section of drywall to a supporting structure as in claim 13, wherein said head end has a recess to accommodate a driving tool.

15. The method of securing a section of drywall to a supporting structure as in claim 13, wherein said first thread diameter is 3-5 millimeters.

16. The method of securing a section of drywall to a supporting structure as in claim 13, wherein said second thread diameter is 12-16 millimeters.

17. The method of securing a section of drywall to a supporting structure as in claim 13, wherein the gap generated is 4-6 millimeters.

18. The method of securing a section of drywall to a supporting structure as in claim 13, wherein the first threaded section is substantially adjacent the second threaded section.
